(19) United States
(12) Patent Application Publication
(10) Pub. No.: US 2013/0174750 A1
(43) Pub. Date: Jul. 11, 2013

(54) METHOD AND APPARATUS FOR PRODUCING MALE DIES FOR EMBOSSING BRAILLE CHARACTERS AND RELATED MALE DIES

(71) Applicant: Franco Foppapedretti, Caravaggio (BG) (IT)

(72) Inventor: Franco Foppapedretti, Caravaggio (BG) (IT)

(73) Assignee: PRO FORM S.R.L., Caravaggio (BG) (IT)

(21) Appl. No.: 13/824,687

(22) PCT Filed: Sep. 5, 2011
(86) PCT No.: PCT/IT11/00307

§ 371 Date: Mar. 18, 2013

(30) Foreign Application Priority Data
Sep. 30, 2010 (IT) MI2010A001797

(51) Int. Cl. B41C 1/08; B41J 3/32; B41M 3/16

(52) U.S. Cl. CPC B41C 1/08; B41M 3/16; B41J 3/32
USPC 101/28; 72/379.2; 72/417

(57) ABSTRACT

A method is provided for producing a laminar male die of the interchangeable type, for printing Braille characters on yielding supports. The method includes the step of punching the metal foil that forms the body of the male die to obtain a plurality of first points in relief on a first face of the foil. The first points define one or more characters in Braille alphabet. The method further includes punching the metal foil to obtain at least two second points in relief on the other side of the foil; the second points in relief are aligned with corresponding receiving seats of an outer male die-holding support. A male die obtained by the method and the respective manufacturing apparatus are also described.

### BACKGROUND OF THE INVENTION

The present invention concerns a method and the respective apparatus for producing male dies intended for embossing Braille characters, in particular for producing laminar metal male dies intended for embossing Braille characters on paper supports. The invention also concerns a male die for printing Braille characters obtained by the above said method and a printing machine provided with the afore said apparatus.

### PRIOR ART

Recently, in order to protect blind persons in many countries the packaging of different consumer goods has been obliged to be provided with writings in “Braille” characters. As known, the Braille writing is based on combinations of points in relief compared with the paper support, the blind persons being able to interpret these points by running the fingertips over.

For example, the European directive n. 2001/83/EC provides that all packs of medicines on the market should be provided with Braille writings, readable by blind persons. These tactile writings must meet precise international standards. In other words, the height, the diameter of the points in relief and the curvature of the respective top are subject to standards.

The German utility model DE 202005020833U describes a packaging for consumer goods of various kinds, provided with Braille characters for blind persons. The points in relief are obtained on paper or paperboard of the package, facing outside to be easily touched by users.

One of the most commonly used systems to create Braille writings on paper supports provides screen printing of points in relief. Points are obtained by depositing on the paper support a thick layer of ink that, at a later time, is hardened by drying, for example by irradiation with UV rays. Systems based on screen printing proved to be expensive.

Alternatively to screen printing, one of the most used system is to directly emboss the points in relief onto the product packaging.

In the present description with the term “embossing” is indicated a mechanical process in which the points of the Braille characters are imprinted in relief in a yielding material, such as leather, fabric, paper, plastics, metals, etc. . . .

Normally, the embossing of points in relief, such points defining the characters of Braille alphabet as mentioned, is implemented by compressing the support of a male die and a counter-male die. The male die, generally made of a hard metallic material, has the points in relief to be embossed and the counter-male die has the corresponding receiving seats of the points in relief. The support is permanently deformed at the portion between each point in relief of the male die and the corresponding receiving seat of the counter-male die.

The male dies and the corresponding counter-male dies can be circular, generally used to emboss supports having the shape of continuous tapes, or flat, normally used to emboss supports in the shape of individual sheets or precut blanks.

The Japanese Patent Application JP 2006235264 describes an apparatus for the embossing of points in relief on tape-shaped paper supports. The apparatus comprises an impression cylinder on whose surface the writings to be embossed on the support in Braille characters are present in relief, and a pushing cylinder arranged in abutment against the impression cylinder. The tape-shaped support, such as a continuous tape of paper or paperboard, is pressed—advanced between the two cylinders rotating in opposite directions and the Braille characters are embossed on the tape-shape support. With this technique it is possible to carry out the embossing directly onto paperboard tapes intended for forming packs of pharmaceutical products.

The embossing of supports made of individual sheets is generally implemented with flat male and counter-male dies arranged to be movable in abutment one to another, for example arranged in a machine for flat die-cutting.

Until a few years ago, in the conventional embossing male dies, both flat and circular, the points in relief defining the Braille characters were obtained with photoengraving techniques, or etching. Disadvantageously these techniques involve high costs and long preparing/executing times.

To overcome these drawbacks alternative technical solutions have been recently proposed, in which the embossing male dies are metal foils applicable interchangeably to the corresponding male die-holding supports. The coupling is typically achieved with glues. The points in relief are substantially conical and are obtained on the metal foil with no expensive photoengraving or etching techniques above described, but they are obtained with cheaper punching or embossing techniques. When it is necessary to replace a male die, for example, because it is worn or to change the Braille text to be embossed on the paper support, it is sufficient to assemble the new male die on the male die-holding support, without changing other parts of the printing machine.

The term “foil” is intended an element having one dimension—the thickness—negligible compared to the other two dimensions—length and width—.

The patent application EP-A-2176071, in the name of the Applicant, describes an apparatus for the production of laminar male dies. A punch is displaced vertically along a first vertical axis, orthogonal relatively to a metal foil, and horizontally along a second axis, transversal relatively to the same metal foil. The metal foil is in its turn moving along a third axis, orthogonal to the first and second axis, its movement being intermittent and synchronized with the movement of the punch. The punch impacts against the upper surface of the foil and deforms it locally, embossing the points in relief on its lower surface, in the expected positions. The embossed foil is cut into several sheets, each of which constituting a male die for embossing Braille characters. The thus obtained laminar male die can be applied to a flat male die-holding support; the male die can be folded (bent) for applying to a cylindrical male die-holding support.

The patent application EP-A-1932657 describes an apparatus provided with laminar curved male dies, mounted interchangeably on corresponding embossing cylinders.

A drawback of the laminar interchangeable male dies can be found during the respective use, especially for large productions.

The replacement of a male die involves the stop of the printing process and the stand-by; this stop is much longer the greater the time required to complete the assembling of the new male die on its support and the respective alignment relatively to the counter-male die is. The alignment is a tricky operation requiring time and expertise by the operator. Normally, the operator manually locates the male die on the respective support (or on a pertinax base fixed to the support), by means of adhesive substances, and it carries out a first alignment relatively the counter-male die with the aid of registers on the male die-holding support. The registers are mostly visual marks on the male die-holding support. The operator then performs one or more printed tests and, based on the geometric characteristics of Braille characters obtained on printed support, it changes the alignment of the male die on the respective support to correct any minimal misalignments relatively to the counter-male die. Obviously the alignment precision thus obtained depends strongly on the operator skill.

An imprecise alignment of the male die relative to its support, and thus also with respect to the counter-male die, can easily lead to a low quality of the embossing of Braille characters when restarting the machine, or even it may result in failure to meet standards. In addition, a male die positioned incorrectly can cause unwanted vibrations in the interaction with the paper support to be embossed and the corresponding counter-male die. Last but not least, an imprecise positioning of the male die relatively to the counter-male die, even of a few millimeter tenths, can easily lead to premature wear of these elements themselves and consequent further production stops for the male die and/or counter-male die replacement.

It has to be considered that in many applications a plurality of male dies must be applied simultaneously on the same male die-holding support, the alignment must be precise for each positioned male die and this further complicates the preparations for the production itself. For example, if the male dies to be placed on the male die-holding support are forty, the alignment must be carried out for all the forty male dies. Possible operator corrections onto some male dies would reflect on all the other male dies, because each male die must be aligned with the support and also in relation to adjacent male dies. It is evident that the male die alignment can be particularly complicated and times for the respective conclusion are quite unpredictable, but long.

Another drawback, although less felt, is the fact that the male die can be slightly misaligned with respect to the corresponding male die-holding support, and then respect to the counter-male die, even during the embossing process (Braille printing), due to vibrations these elements are subjected to.

The described drawbacks are felt to a lesser extent in machines provided with circular male and counter-male dies, as the male die curvature aids to maintain the centering, but they can have a significant impact on machines provided with flat male and counter-male dies.

### SUMMARY OF THE INVENTION

The object of the present invention is to provide a method for producing male dies for embossing Braille characters solving the drawbacks of common solutions.

In particular, it is an object of the present invention to provide a method for manufacturing male dies for embossing Braille characters that is easy and economic to implement, allowing to obtain laminar male dies to be aligned easily relatively to the respective male die-holding support with the highest precision.

It is a further object of the present invention to provide a laminar male die for embossing Braille characters that is easy to align with the highest precision relatively to the corresponding counter-male die and even to other male dies of the same type located on the respective male die-holding support.

The present invention relates therefore, in its first aspect, to a method according to claim 1 for manufacturing an interchangeable laminar male die for embossing Braille characters on yielding supports.

Particularly, the method according to the present invention comprises the steps of:
a) providing a metal foil provided with an upper face and a lower face;
b) locally deforming said metal foil to obtain a plurality of first points in relief on one from the upper face and the lower face of the foil, said first points defining one or more characters in Braille alphabet;
c) locally deforming said metal foil to obtain at least two seconds points in relief on the other from the upper face and the lower face of the foil, said second points in relief being aligned with corresponding receiving seats of an outer male die-holding supports.

With the term interchangeable it is intended to point out that the male die is obtained as a metal foil able to be applied to the respective male die-holding support and replaced, if necessary, based on production needs, in the aforesaid methods.

With the term “yielding support” it is intended generically to indicate any material suitable to be embossed with points in relief defining the Braille alphabet. Supports of this type are, for example, paper, paperboard, hide, leather, some plastics, thin metallic sheets, etc. . . .

Advantageously, the method according to the present invention provides the step of c) obtaining at least two points of alignment, in relief, at the male die face opposite to the face on which the points, that will emboss tactile Braille writings on the support to be printed, are obtained. The alignment points are not intended for embossing the yielding support, but they serve to achieve a rapid and precise alignment of the metal foil, that is the male die, relatively to the corresponding male die-holding support. In addition, the alignment points aid to hold the male die in the correct position during use too, when it is subjected to vibrations. The coupling between the alignment points and respective receiving seats restrict or impede the rotations and misalignments of the male die with respect to the respective support.

Thanks to the present invention, the average times needed to align a male die with respect to respective support, and then to the counter-male die, can be reduced drastically, up to ⅓ of the whole duration usually required by traditional systems.

On the male die-holding support at least a corresponding number of seats receiving the aligned points of relief is arranged. The operator for the male die positioning on respective support therefore takes advantage. The precise alignment of the male die relatively to the counter-male die is obtained simply by inserting the alignment points of the male die into the corresponding receiving seats of the male die-holding support, in their turn obtained in optimal and precise alignment with respect to the male die.

A male die-holding support expressly designed with the afore described receiving seats falls within the scope of the present invention and it is the subject of claim 13.

Advantageously each alignment point is inserted in the corresponding receiving seat with a male-female coupling of a substantially conical type, aiding the self-centering of the alignment points with respect to the receiving seats and, therefore, it aids the exact alignment preservation of the male die during the embossing of the yielding supports, when the vibrations may act to misalign the male die relatively to the counter-male die.

The steps b) and c) of the method according to the present invention may be implemented in chronological order, with step b) preceding the step c), or vice versa, or substantially simultaneously.

Preferably the metal foil is rectangular and the second points in relief, that is the alignment points, are at least three, each one obtained at a corner of the foil.

Preferably, steps b) and c) are implemented by means of one or more movable punches in abutment against the surface of metal foil, alternately along a direction perpendicular to both upper and lower faces.

Generally, the punch is provided with a single tip intended for interacting with the metal foil. Alternatively, the punch can be provided with several side by side and integral tips, for example, a single punch can be formed so as to emboss at the same time the foil with its nine tips identifying a particular character in Braille alphabet. In other words, the punch can itself be formed as a letter in Braille alphabet.

Preferably the first and second alignment points in relief have the same geometrical characteristics. Alternatively, the second points in relief have a substantially different diameter and/or height, for example greater, than the diameter/height of the first points in relief.

The present invention relates therefore, in its third aspect, to a male die according to claim 6 for embossing Braille characters on yielding supports.

In particular, the male die includes a plurality of first points in relief, projecting from a first face of the laminar male die and defining one or more marks in Braille alphabet, and it is characterized by comprising at least two second points in relief, projecting from the second face of the laminar male die opposite said first face, wherein said second points in relief can be inserted into corresponding receiving seats of an outer support of the laminar male die.

In other words, the first points in relief and the second points in relief extend in the direction opposite to the metal foil forming the body of the male die.

Preferably the male die comprises one or more of the following characteristics:
d) the foil that forms the body of the mail die is rectangular;
e) there are at least three second points in relief and they define two perpendicular axes parallel to the foil;
f) the first points in relief and the second points in relief have the same geometric characteristics or else the second points in relief have a different diameter and/or height with respect to the first points in relief;
g) each of the second point in relief has a substantially conical extension;
h) the plate is flat or curved.

The foil, initially flat, can be bent after being embossed with points in relief for the use with circular male die-holding supports.

In accordance with the present invention, the male die-holding support comprises at least two receiving seats of the second points in relief of the male die. These seats have a substantially complementary shape relatively to the shape of points in relief so as to realize a conical coupling therewith having the above described characteristics.

It is a further object of the present invention to provide an apparatus for producing laminar male dies of the afore said type.

The present invention relates therefore, in its fourth aspect, to a apparatus according to claim 8 for manufacturing a laminar male die to be used for embossing Braille characters on yielding supports.

In particular, the apparatus comprises:
i) a device for advancing a foil along a first direction,
l) a first punch able to move perpendicularly and parallel with respect to the foil, along a second direction and a third direction, respectively, to imprint first points in relief at a first face of the foil,
characterized by further comprising,
l) a second punch able to move perpendicularly with respect to the foil, along a fourth direction parallel to the second direction, to imprint second points in relief at the second face of the foil opposite the first face, or alternatively,
m) means for turning over the foil with respect to said first punch to allow the latter to also imprint second points in relief at the second face of the foil.

Advantageously, the apparatus allows to imprint points in relief on both sides of the foil, that forms the body of the mail die. This is achieved by providing the apparatus of a second punch (in addition to the punch imprinting points in relief according to the Braille characters), or arranging a foil repositioning station that rotates the foil itself with respect to the first punch.

For example, once all the first points in relief have been embossed on the first face of the foil, the latter it is turned over (180°) and subjected again to the first punch.

The apparatus is simple to implement because it comprises already widely used elements for the embossing of the laminar male dies. In addition the apparatus can be also installed on existing machines, that can be modified by the addition of a second punch or a turning over unit for the foil or the first punch.

Preferably the advancing movement of the foil is translating, intermittent, and synchronized with the movement of the first punch and/or second punch. The foil is stopped when the first punch and/or the second punch go(es) in abutment against the foil surface to imprint points in relief.

Preferably the first direction lies in a horizontal working plane, the second direction is orthogonal to the working plane and the third direction is parallel to the working plane.

In its fifth aspect the invention concerns a machine for printing Braille characters on yielding supports, such as paper, cardboard, paperboard, hide, plastic, etc. . . . , including the described above apparatus.

### BRIEF DESCRIPTION OF THE FIGURES

Further characteristics and advantages of the present invention will be more evident from the following description of its preferred embodiment, made herein below, for illustration purposes only and without limitation, with reference to the attached drawings. In such drawings:

FIG. 1 is a top perspective view of a laminar male die according to the present invention intended for embossing Braille characters on yielding supports;

FIG. 2 is a bottom perspective view of the male die shown in FIG. 1;

FIG. 3 is a side view of the male die shown in FIG. 1;

FIG. 4 is a side view of the male die shown in FIG. 1 and a corresponding counter-male die;

FIG. 5 is a top perspective view of an apparatus according to the present invention;

FIG. 6 is a partially sectioned plan view of the apparatus shown in FIG. 5;

FIG. 7 is a front view of a first detail of the apparatus shown in FIG. 5;

FIG. 8 is a cross section view of a second detail of the apparatus shown in FIG. 5;

FIG. 9 is a cross section view of a third detail of the apparatus shown in FIG. 5;

FIG. 10 is a cross section and partial view of the detail shown in FIG. 9.

### DETAILED DESCRIPTION OF A PREFERRED EMBODIMENT OF THE INVENTION

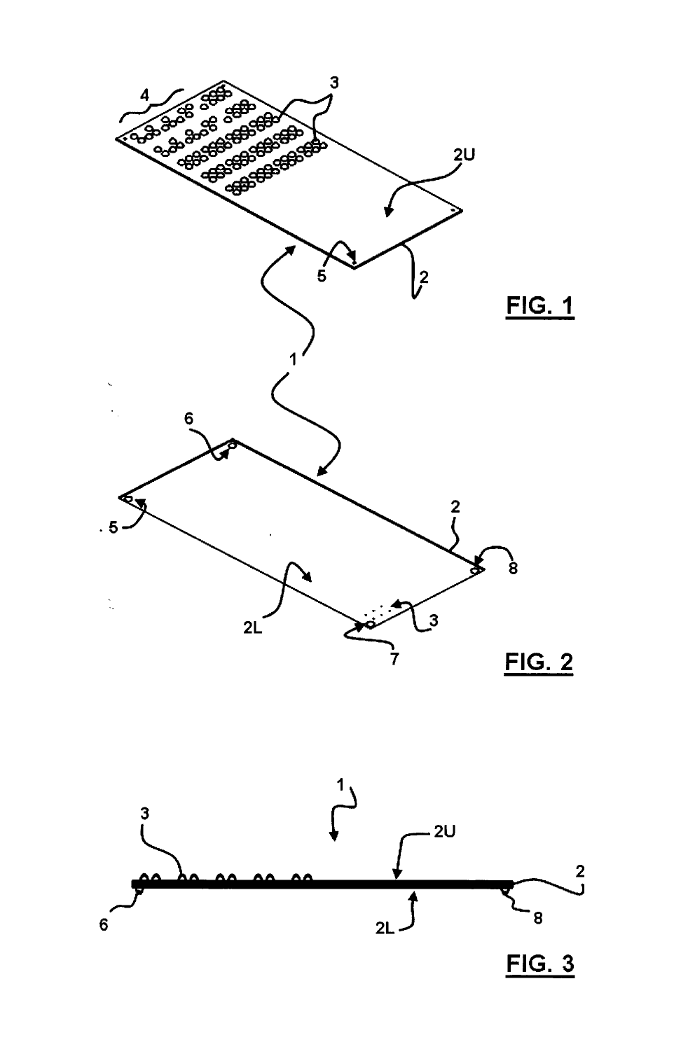

With reference to the attached figures, and in particular with reference to FIGS. 1-3, with the reference number 1 is generally indicated a male die according to the present invention for embossing Braille characters on yielding supports such as, for example, paper, cardboard, paperboard, hide, fabrics, plastics, wood, etc. . . . In particular, the male die 1 is particularly suitable for embossing Braille characters on paperboard precut blanks intended for packaging of drugs.

The body 2 of the male die 1 is a metal foil, such as a steel foil whose thickness is negligible compared to its length and width. The male die 1 is of exchangeable type, that is intended for being coupled to a male die-holding support of a machine for embossing the above described supports.

The male die 1 comprises a plurality of points in relief 3 obtained on one of the two faces of the laminar body 2, for example the upper face 2U. Each point in relief has such geometric characteristics to imprint corresponding Braille points on the embossed support according to the requirements of the above mentioned standards. The points in relief 3 are arranged on the surface of the male die 1 to define corresponding characters or symbols 4 in Braille alphabet.

Preferably the points in relief 3 are obtained by punching or embossing techniques.

Advantageously, the male die 1 according to the present invention includes at least two points in relief 5, 6 projecting on the other side 2L of the laminar body 2 of the male die, i.e. the lower face 2L opposite to the upper face 2U. Preferably, as in the embodiment shown in FIGS. 1-3, the points in relief obtained on the lower surface 2L are at least three, and precisely four 5-8, each positioned at one corner of the laminar body 2. Alternatively, the points in relief 5, 6 and possibly 7, 8 are located in any portion of the face 2L of the male die 1, provided that they do not interfere with the points in relief 3.

The points in relief 5-8 are not used to emboss corresponding points in relief in the supports to be printed with Braille characters, but instead have the function of simplifying and optimizing the alignment of the male die 1 with respect to its male die-holding support, in a printing machine, and thus indirectly also with respect to the counter-male die.

Preferably the line passing through the points in relief 5 and 6 and the line passing through the points in relief 5 and 7 are orthogonal.

Preferably the points in relief 3 and 5-8 have identical geometrical characteristics and they are substantially conical. Alternatively, the points in relief 5-8 have diameters and/or height (or depth) greater than the points in relief 3.

The male die 1 shown in attached Figures is flat. However, it can be bent for mounting on cylindrical male die-holding supports.

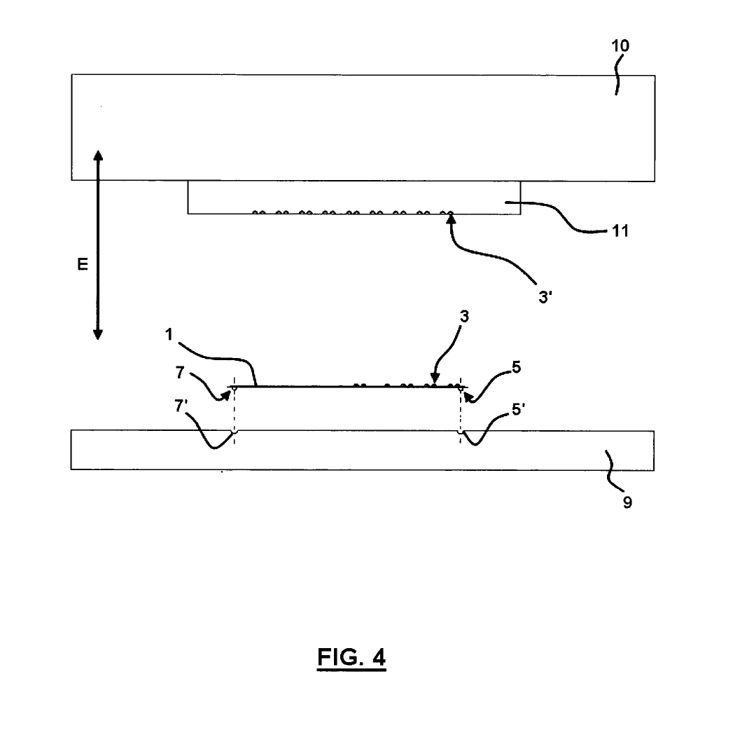

FIG. 4 shows a machine for printing, or embossing, Braille characters on paperboard and it is useful for understanding the advantages of the present invention. The machine structure is substantially equivalent to that of a machine for flat die-cutting, with the difference that instead of threads for cutting or creasing the paperboard there are the male die 1 and the corresponding counter-male die 11.

The counter-male die 11 is attached to a upper supporting plate 10 movable reciprocally relatively to a stationary lower supporting plate 9, as indicated by the double arrow E. The motion extent is such to bring the counter-male die 11 in abutment or almost in abutment against the male die 1 attached to the lower supporting plate 9.

The counter-male die 11 is provided with a plurality of seats 3′ for receiving the points in relief 3 of the male die 1. The male die 1 is shown separated from the supporting plate 9 for more clarity, but in use it is attached to the supporting plate 9, for example by means of a double-sided tape or glues, so that the points in relief 3 are still facing the counter-male die 11.

The lower supporting plate 9 is provided with seats 5′-8′ for receiving the points in relief 5-8 of the male die. Advantageously the correct alignment between the points in relief 3 of the male die 1 and the receiving seats 3′ of the counter-male die 11 is aided, if not guaranteed, by the coupling between the points in relief 5-8 obtained on the lower face of the male die 1 and the corresponding receiving seats 5′-8′ obtained into the supporting plate 9.

The receiving seats 5′-8′ are obtained in the supporting plate 9, with punching or machining techniques, in predetermined positions, with the utmost precision. The coupling between the points in relief 5-8 of the male die 1 and the receiving seats 5′-8′ is preferably conical, and therefore substantially self-centering.

Whenever the replacement of the male die 1 with a new male die becomes necessary, the alignment of the new male die with respect to the supporting plate 9 is obtained automatically attaching the new male die 1 on the upper surface of the plate 9, taking care to include the points in relief 5-8 in the receiving seats 5′-8′.

This feature allows to simplify the procedure for replacing the male die 1 and to minimize the downtime duration, to the benefit of production.

Moreover, the high alignment precision that can be obtained as above described allows to maintain the quality standards over time required by the regulations regarding the embossing of Braille characters. In fact the substantially conical coupling between the points in relief 5-8 and the receiving seats 5′-8′ is firm also during the support embossing, when vibrations are generated.

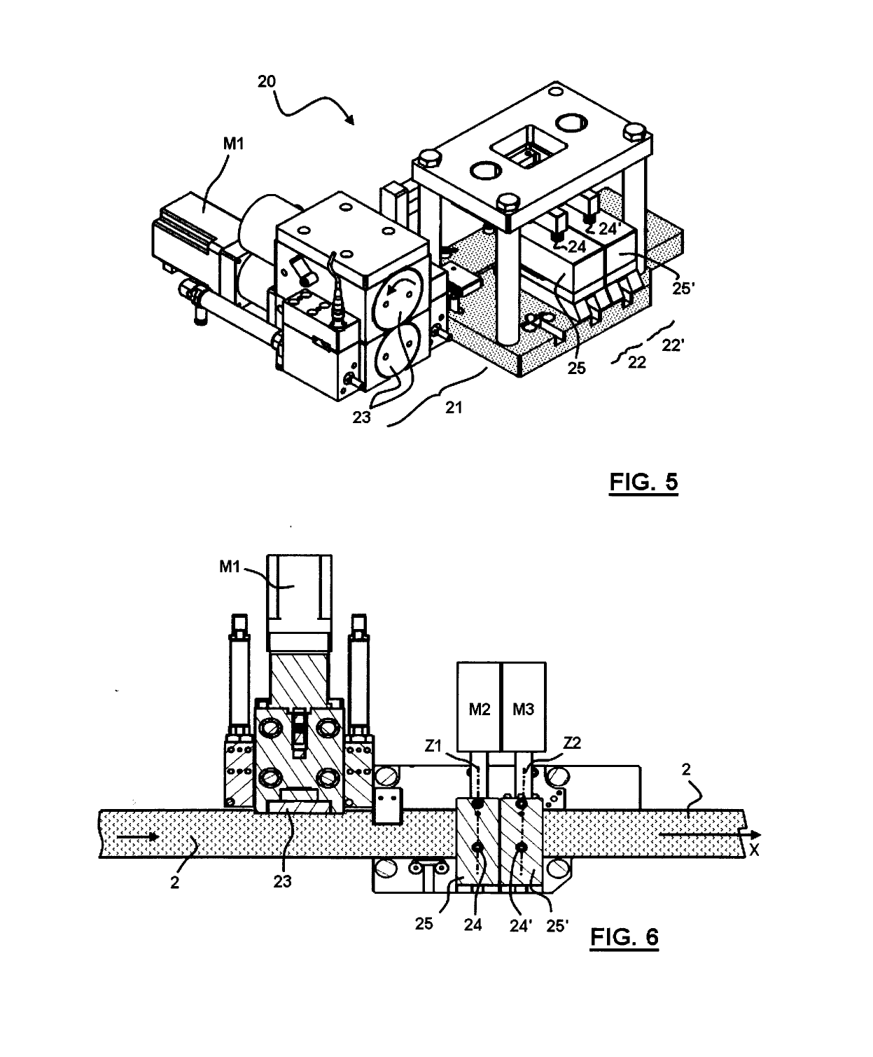

FIGS. 5 and 6 show in perspective and from top, an apparatus 20, partially sectioned, according to the present invention for the production of the above described male die 1. The apparatus 20 can be mounted in an automatic machine for embossing Braille characters on precut blanks, such as paperboard.

Generally, the apparatus 20 comprises a device 21 for advancing a foil 2 along a first direction X lying in a working plane and a first punch 24. The advancing device 21 comprises two wheels 23 operable rotationally by a motor M1 around corresponding axes parallel to each other; the foil 2, that will form the body of the male die 1 is pressed between the wheels 23, driven rotationally in an opposite way one each other. Convenient sensors, such as active optical encoders on the shaft of at least one of the wheels 23, provide the measure of the advancement given to the foil 2. In the solution shown in the figures, the foil 2 is moving in the X direction in a horizontal working plane.

Downstream of the device 21 with respect to the advancing direction X there is a punching station 22 provided with the punch 24. The punch 24, as best seen in FIG. 8, is movable along two axes Y and Z1 orthogonal one another and orthogonal to the advancing direction X of the foil 2.

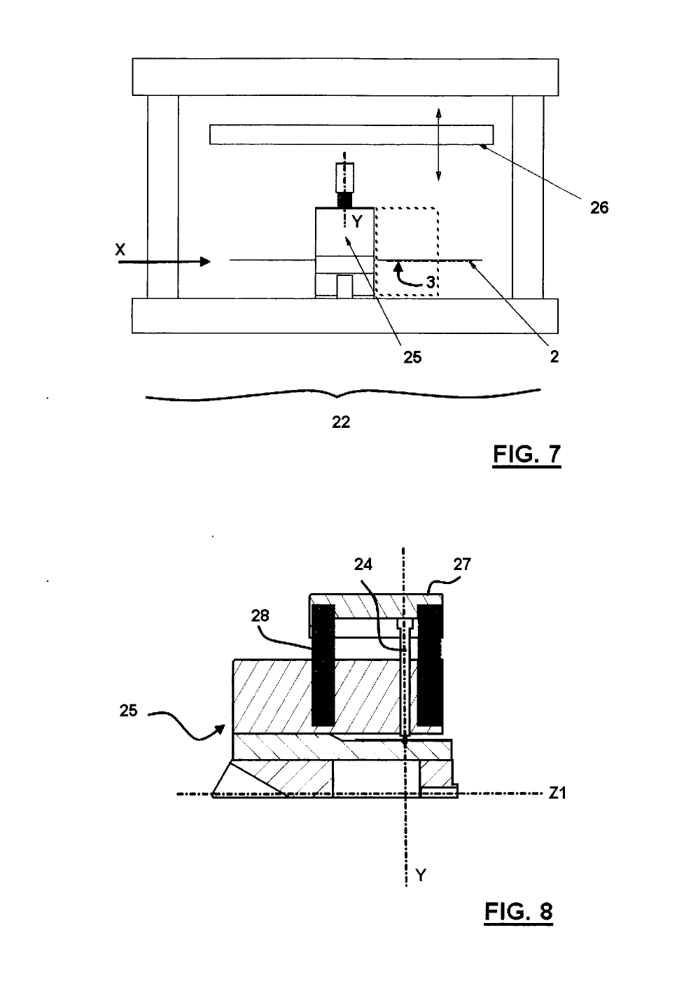

In particular, with reference to FIGS. 5-8, the punch 24 is housed in a cartridge 25 provided with a specific vertical seat, in practice a through hole. The punch is reciprocally sliding in the Y direction in the seat of the cartridge 25 and the respective movement is opposed by return springs 28. The punching station 22 is provided with a vertically movable horizontal plate 26, as indicated by the arrow in FIG. 7, to control the lowering of the element 27 of the cartridge the punch is constrained thereto and, accordingly, to bring the punch 24 in abutment against the upper surface of the foil 2 to emboss a point in relief 3 on the respective lower surface. The raising of the plate 26 causes the return of the punch 24 in the initial position raised from the foil 2. Obviously the movement of the punch 24 is synchronized with the advancing movement of the foil 2 as explained above.

The cartridge 25 is further shiftable reciprocally along a horizontal axis Z1, orthogonal to the advancing direction X, to move the punch 24 and cover the width of the blade 2. In this regard, the station 22 comprises a motor M2. FIG. 8 is a cross section of the cartridge 25 considered along a vertical plane containing the Z axis.

In a first embodiment the apparatus 20 comprises a second punching station 22′ provided with a cartridge 25′ equivalent to the cartridge 25, but active on the lower surface of the foil 2 to emboss the alignment points on the respective upper surface. The cartridge 25′ can be placed upstream of the cartridge 25 with respect to the advancing direction of the foil, but preferably it is placed downstream thereof, as shown in FIG. 5.

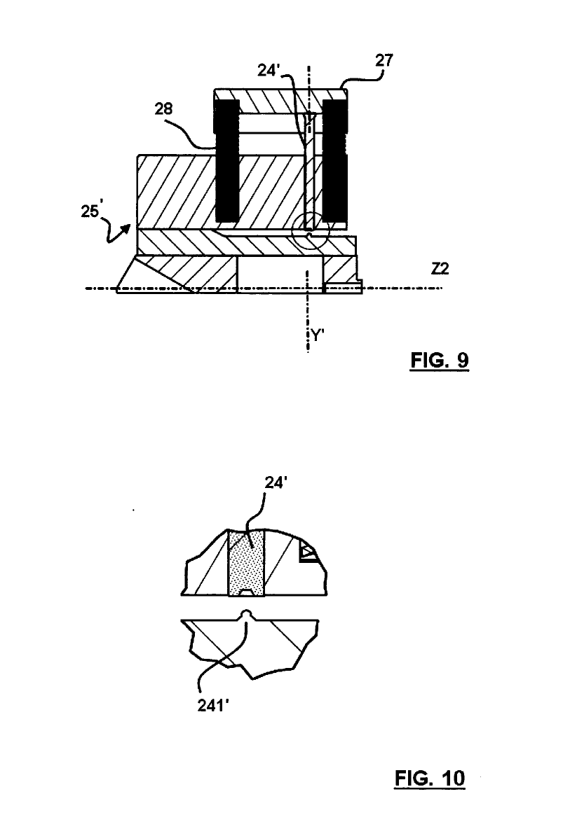

LThe second punching station 22′ is shown in section in FIG. 9. FIG. 10 is an enlarged section of the second punch 24′ and the corresponding abutment portion 241′ of the cartridge 25′.

The second station 22′ is similar to the first station, and it moves along the axes Y′ and Z2 parallel to the axes Y and Z1, respectively, with the difference that the second punch 24′ is female, that is its tip is concave, and the corresponding abutment portion 241′ of the cartridge 25′ is male, that is it is projecting towards the foil 2, to fit into the tip concavity of the second punch 24′. The interaction of the punch 24′ and the abutment portion 241′ allows to emboss the points in relief 5-8 in the opposite direction relatively to the points in relief 3 embossed in the first punching station 22, while maintaining the cartridge 25′ side by side the cartridge 25, i.e. at the same side with respect to the foil 2.

In the shown embodiment, the second punching station is translationally operated along the axis Z2 by a corresponding motor M3, but preferably the motor M2 of the first station also controls the operation of the second station.

In an alternative embodiment, not shown, the apparatus 20 comprises means to turning over the foil 2 and feed it back to the punching station 22 with upper and lower surfaces reversed, so that the punch 24 could emboss the alignment points on the surface of the foil 2 opposite to the surface where the points in relief were or will be embossed 3.

Advantageously the apparatus 2 has a very simple structure and layout and it allows to emboss the alignment points 5-8 in the foil 2 with the same punch 24 the points in relief 3 of the Braille characters are embossed therewith.

Downstream of the punching station 22 the apparatus 20 may include a curvature station of the foil 2 and/or a cutting/shearing station separating defined portions of the machined foil 2 to obtain the male die 1 shown in FIGS. 1-3.

1. Method for producing an interchangeable male die (1) for embossing Braille characters (4) on yielding supports, comprising the steps of:
a) providing a metal foil (2) provided with an upper face (2U) and a lower face (2L);
b) locally deforming said metal foil (2) to form a plurality of first points in relief (3) on one (2U) from the upper face and the lower face of the metal foil (2), said first points in relief (3) defining one or more characters (4) in the Braille alphabet;
c) locally deforming said metal foil (2) to form at least two second points in relief (5-8) on the other (2L) from the upper face and the lower face of the foil, said second points in relief (5-8) being aligned with corresponding receiving seats (5′-8′) of an outer male die-holding support (9).

2. Method according to claim 1, wherein said metal foil (2) is rectangular and there are at least three of said second points in relief (5-8), each formed near to a corner of the metal foil (2).

3. Method according to claim 1, wherein said second points in relief (5-8) are formed in an intermediate position between adjacent first points in relief (3).

4. Method according to claim 1, wherein said steps b) and c) are carried out by means of at least one punch (24) moveable in abutment against a surface of the metal foil (2), alternately along a direction (Y) perpendicular to the two upper (2U) and lower (2L) faces.

5. Method according to claim 1, wherein said first points in relief (3) and said second points in relief (5-8) have the same geometric characteristics, or said second points in relief (5-8) have a substantially different diameter and/or height with respect to the diameter/height of said first points in relief (3).

6. Laminar male die (1) for embossing Braille characters (4) on yielding supports, comprising a plurality of first points in relief (3), projecting from a first face (2U) of the laminar male die (1) and defining one or more marks (4) in the Braille alphabet, and at least two second points in relief (5-8), projecting from a second face (2L) of the laminar male die (1) opposite said first face (2U), wherein said second points in relief (5-8) can be inserted into corresponding receiving seats (5′-8′) of an outer support (9) of the laminar male die (1).

7. Male die (1) according to claim 6, further comprising at least one of the following characteristics:
the foil (2) that forms the body of the male die (1) is rectangular;
there are at least three second points in relief (5-8) and they define two perpendicular axes parallel to said foil (2);
the first points in relief (3) and the second points in relief (5-8) have the same geometric characteristics or else the second points in relief (5-8) have a different diameter and/or height with respect to the first points in relief (3);
each of said second points in relief (5-8) has a substantially conical extension; or
said foil (2) is flat or curved.

8. Apparatus (20) for producing laminar male dies (1) intended for embossing Braille characters (4) on yielding supports, the apparatus (20) comprising:
a device (21) for advancing a foil (2) along a first direction (X);
a first punch (24) able to move perpendicularly with respect to said foil (2), along a second direction (Y), to imprint first points in relief (3) at a first face (2U) of the foil (2),
a second punch able to move perpendicularly with respect to said foil, along a direction parallel to said second direction, to imprint second points in relief at a second face (2L) of the foil (2) opposite the first face (2U), or alternatively,
a device configured to turn over said foil (2) with respect to said first punch (24) to allow said first punch (24) to also imprint second points in relief (5-8) at the second face (2L) of the foil (2).

9. Apparatus (20) according to claim 8, wherein at least one from said first punch (24) and said second punch (24′) is able to translate along a third direction (Z1, Z2) perpendicular to said first direction (X) and to said second direction (Y,Y′).

10. Apparatus (20) according to claim 8, wherein the advancing movement of said foil (2) is translating, intermittent, and synchronised with the movement of said first punch (24) and/or of said second punch, said foil (2) being stopped when said first punch (24) and/or said second punch go(es) into abutment against a surface of the foil to imprint points in relief (3, 4).

11. Apparatus (20) according to claim 9, wherein said first direction (X) lies in a horizontal working plane, said second direction (Y) is perpendicular to the working plane and said third direction (Z) is parallel to the working plane.

12. Machine for producing flat or curved laminar male dies for embossing. Braille characters on yielding supports, comprising an apparatus (20) according to claim 8.

13. Male die-holding support (9) for machines configured for embossing yielding materials, comprising a seat for housing the laminar male die (1) according to claim 6, further comprising at least two seats (5,-8′) for receiving the second points in relief (5-8) of said male die (1).
